(19) United States
(12) Patent Application Publication
(10) Pub. No.: US 2025/0148790 A1
(43) Pub. Date: May 8, 2025

(54) POSITION-AWARE TEMPORAL GRAPH NETWORKS FOR SURGICAL PHASE RECOGNITION ON LAPAROSCOPIC VIDEOS

(71) Applicant: DIGITAL SURGERY LIMITED, London (GB)

(72) Inventors: Abdolrahim Kadkhodamohammadi, London (GB); Imanol Luengo Muntion, London (GB); Danail V. Stoyanov, London (GB)

(21) Appl. No.: 18/684,292

(22) PCT Filed: Aug. 18, 2022
(86) PCT No.: PCT/EP2022/073102

§ 371 Date: Feb. 16, 2024

Related U.S. Application Data
(60) Provisional application No. 63/235,027, filed on Aug. 19, 2021.

(51) Int. Cl. G06V 20/40; G06V 10/62; G06V 10/82

(52) U.S. Cl. CPC G06V 20/49; G06V 10/62; G06V 10/82; G06V 20/41; G06V 2201/03

(57) ABSTRACT

Data captured during a surgical procedure can include video streams, such as from a laparoscopic camera. Technical solutions are described to facilitate online surgical phase recognition from the captured video stream(s). Surgical phase recognition is key in developing context-aware supporting systems for surgeons and medical teams in general. The technical solutions describe taking temporal context in videos into account by precise modeling of temporal neighborhoods in a video.

### CROSS REFERENCE TO RELATED APPLICATION

This application is a PCT application which claims the benefit of U.S. Provisional Patent Application No. 63/235,027, filed on Aug. 19, 2021.

### BACKGROUND

The present invention relates in general to computing technology and relates more particularly to computing technology for automatic detection of features such as surgical phases, using machine learning prediction, in captured surgical data. Further, aspects described herein facilitate improvements to computer-assisted surgical systems that facilitate the provision of surgical guidance based on audiovisual data and machine learning.

Computer-assisted systems, and particularly computer-assisted surgery systems, rely on video data digitally captured during a surgery. Such video data can be stored and/or streamed or processed during a surgical procedure. In some cases, the video data can be used to augment a person's physical sensing, perception, and reaction capabilities or the capabilities of an instrument. For example, such systems can effectively provide the information corresponding to an expanded field of vision, both temporal and spatial, that enables a person to adjust current and future actions based on the part of an environment not included in his or her physical field of view. Alternatively, or in addition, the video data can be stored and/or transmitted for several purposes such as archival, training, post-surgery analysis, event logging, patient consultation, etc.

### SUMMARY

A computer-implemented method includes computing, by a processor, using an encoder machine learning model, a plurality of frame features respectively corresponding to a plurality of video frames from a surgical video, each frame feature being a latent representation of the corresponding video frame from the surgical video. The method further includes generating, by the processor, using a decoder machine learning model, a position-aware temporal graph data structure that comprises a plurality of nodes and a plurality of edges, wherein each node represents a respective frame feature and an edge between two nodes indicates a relative position of the two nodes. The method further includes aggregating, by the processor, an embedding at each node, the embedding at a first node is computed by applying an aggregation function to the embedding of each node connected to the first node. The method further includes generating, by the processor, phase labels for the nodes based on the embedding at each node. The method further includes identifying, by the processor, one or more surgical phases in the surgical video based on the phase labels.

According to one or more aspects, a subset of the nodes is associated with a first phase based on each of the subset of the nodes having the same phase label.

According to one or more aspects, the method further includes storing, by the processor, information about the one or more surgical phases, the information identifying the video frames from the surgical video corresponding to the one or more surgical phases.

According to one or more aspects, the surgical video is captured using a camera that is one from a group comprising an endoscopic camera, a laparoscopic camera, a portable camera, and a stationary camera.

According to one or more aspects, the phase labels are generated using computer vision based on the latent representation.

According to one or more aspects, the method further includes, generating a user interface that comprises a progress bar with a plurality of sections, each section representing a respective surgical phase from the one or more surgical phases.

According to one or more aspects, the progress bar is updated in real-time as the surgical video is being captured and processed.

According to one or more aspects, each of the sections is depicted using a respective visual attribute.

According to one or more aspects, the visual attribute comprises at least one of a color, transparency, icon, pattern, and shape.

According to one or more aspects, selecting a section causes a playback of the surgical video to navigate to a surgical phase corresponding to the section.

According to one or more aspects, the decoder machine learning model is a graph neural network.

According to one or more aspects, the graph neural network includes a first block comprising a series of calibration layers, a second block comprising a predetermined number of graph convolution layers, and a third block comprising a classification head.

According to one or more aspects, a system includes a machine learning system that includes an encoder that is trained to encode a plurality of video frames of a surgical video into a corresponding plurality of frame features. The machine learning system further includes a temporal decoder that is trained to segment the surgical video into a plurality of surgical phases, each surgical phase comprising a subset of the plurality of video frames. Segmenting the surgical video by the temporal decoder includes generating a position-aware temporal graph that comprises a plurality of nodes and a plurality of edges, each node represents a corresponding frame feature, and an edge between two nodes is associated with a time step between the video frames associated with the frame features corresponding to the two nodes. Segmenting the surgical video by the temporal decoder includes aggregating, at each node, information from one or more adjacent nodes of the each node. Segmenting the surgical video by the temporal decoder includes identifying a surgical phase represented by each video frame based on the information aggregated at the each node.

In one or more aspects, the machine learning system further comprises outputting the surgical phases identified.

In one or more aspects, a surgical phase represented by each video frame is identified based on a latent representation of the video frame that is encoded into a frame feature.

In one or more aspects, the position-aware temporal graph is generated using a graph neural network.

According to one or more aspects, a computer program product includes a memory device having computer-executable instructions stored thereon, which when executed by one or more processors cause the one or more processors to perform a method to autonomously identify surgical phases in a surgical video. The method includes generating, using a machine learning system, a position-aware temporal graph to represent the surgical video, the position-aware temporal graph comprises a plurality of nodes and a plurality of edges, each node comprises a latent representation of a corresponding video frame from the surgical video, and an edge between two nodes is associated with a time step between the video frames corresponding to the two nodes. The method further includes, for each layer of a graph neural network, aggregating, at each node, latent representations of adjacent nodes at a predefined time step associated with each layer, the graph neural network comprising a predetermined number of layers. The method further includes identifying a surgical phase represented by each video frame based on the aggregated information at the each node.

In one or more aspects, the each layer of the graph neural network is associated with a distinct predefined time step.

In one or more aspects, the method further comprises storing a starting timepoint and an ending timepoint of the surgical phase based on a set of sequential video frames identified to represent the surgical phase.

In one or more aspects, the surgical video is a real-time video stream.

In one or more aspects, the surgical video is processed post-operatively.

Additional technical features and benefits are realized through the techniques of the present invention. Aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the aspects of the invention are apparent from the following detailed description taken in conjunction with the accompanying drawings in which:

FIG. 1 shows a computer-assisted surgery system according to one or more aspects;

FIG. 2 shows a system for analyzing the video captured by a video recording system according to one or more aspects;

FIG. 3 depicts a block diagram of video-based phase recognition being performed using machine learning according to one or more aspects;

FIG. 4 depicts an example position-aware temporal graph according to one or more aspects;

FIG. 5 depicts a flowchart of a method for surgical phase recognition in a surgical video using machine learning models utilizing a position aware temporal graph according to one or more aspects;

FIG. 6 depicts comparison of experimental results of recognizing surgical phases across a video using different techniques;

FIG. 7 depicts a user interface for representing surgical phases automatically recognized in a surgical video using machine learning according to one or more aspects;

FIG. 8 depicts a computer system according to one or more aspects; and

FIG. 9 depicts a surgical procedure system in accordance with one or more aspects.

The diagrams depicted herein are illustrative. There can be many variations to the diagram, or the operations described therein without departing from the spirit of the invention. For instance, the actions can be performed in a differing order, or actions can be added, deleted, or modified. Also, the term “coupled,” and variations thereof describe having a communications path between two elements and do not imply a direct connection between the elements with no intervening elements/connections between them. All of these variations are considered a part of the specification.

### DETAILED DESCRIPTION

In exemplary aspects of the technical solutions described herein, a computer-assisted surgical (CAS) system is provided that uses one or more machine learning models to capture, as surgical data, data that is sensed by an actor involved in performing one or more actions during a surgical procedure (e.g., a surgeon). The surgical data includes one or more surgical videos and associated device information. For example, the device information can include signals collected during surgery (e.g., data from instruments, energy devices, robotic motion controllers, or other imaging sources). Exemplary aspects of the technical solutions described herein improve the CAS system by facilitating automatic video-based surgical phase recognition. The technical solutions described herein use graph neural networks (GNNs), and in some aspects, position-aware temporal graph networks (PATG networks) to facilitate the automatic surgical phase recognition (phase recognition/detection/identification).

The surgical data that is captured can include one of more videos of a surgical procedure (“surgical video”), which may be captured using an endoscopic or microscopic camera passed inside a patient adjacent to the location of the surgical procedure to view and record one or more actions performed during the surgical procedure. A video may also come from a camera mounted in the operating room and external to the surgical site. The video that is captured can be transmitted and/or recorded in one or more examples. In some examples, the video can be analyzed and annotated post-surgery. A technical challenge exists to store the vast amounts of video data generated due to the numerous surgical procedures performed. Exemplary aspects of technical solutions described herein relate to, among other things, devices, systems, methods, computer-readable media, techniques, and methodologies for maintaining video of surgical procedures.

Additionally, exemplary aspects of technical solutions described herein relate to, among other things, devices, systems, methods, computer-readable media, techniques, and methodologies for using machine learning and computer vision to automatically predict or detect surgical phases, anatomical information, and instrument information in surgical data. More generally, aspects can include object detection, motion tracking, and predictions associated with one or more structures, the structures being deemed to be critical for an actor involved in performing one or more actions during a surgical procedure (e.g., by a surgeon) or to determine the importance of a surgical phase or process. A predicted structure can be an anatomical structure, a surgical instrument, an event, etc. Alternatively, or in addition, the structures are predicted in an offline manner, for example, from stored surgical data.

The surgical data provided to train the machine learning models can include data captured during a surgical procedure and simulated data. The surgical data can include time-varying image data (e.g., a simulated/real video stream from diverse types of cameras) corresponding to a surgical environment. The surgical data can also include other types of data streams, such as audio, radio frequency identifier (RFID), text, robotic sensors, energy profiles from instruments, other signals, etc. The machine learning models are trained to predict and identify, in the surgical data, “structures,” including particular tools, anatomic objects, actions being performed in the simulated/real surgical stages. In one or more aspects, the machine learning models are trained to define one or more models' parameters to learn how to transform new input data (that the models are not trained on) to identify one or more structures. During the training, the models receive, as input, one or more data streams that may be augmented with data indicating the structures in the data streams, such as indicated by metadata and/or image-segmentation data associated with the input data. The data used during training can also include temporal sequences of one or more input data.

In one or more aspects, the simulated data can be generated to include image data (e.g., which can include time-series image data or video data and can be generated in any wavelength of sensitivity) that is associated with variable perspectives, camera poses, lighting (e.g., intensity, hue, etc.) and/or motion of imaged objects (e.g., tools). In some instances, multiple data sets can be generated—each of which corresponds to the same imaged virtual scene but varies with respect to perspective, camera pose, lighting, and/or motion of imaged objects, or varies with respect to the modality used for sensing, e.g., red-green-blue (RGB) images or depth or temperature or specific illumination spectra or contrast information. In some instances, each of the multiple data sets corresponds to a different imaged virtual scene and further varies with respect to perspective, camera pose, lighting, and/or motion of imaged objects.

The machine learning models can include, for instance, a fully convolutional network adaptation (FCN), graph neural network (GNN), position-aware temporal graph (PATG) networks, and/or conditional generative adversarial network model. In some aspects, the machine learning models can be configured with one or more hyperparameters for phase and/or surgical instrument detection. For example, the machine learning models can be configured to perform supervised, self-supervised, or semi-supervised semantic segmentation in multiple classes—each of which corresponding to a particular surgical instrument, anatomical body part (e.g., generally or in a particular state), and/or environment. Alternatively, or in addition, the machine learning model (e.g., the conditional generative adversarial network model) can be configured to perform unsupervised domain adaptation to translate simulated images to semantic instrument segmentations. It is understood that other types of machine learning models or combinations thereof can be used in one or more aspects. Machine learning models can further be trained to perform surgical phase detection and may be developed for a variety of surgical workflows, as further described herein. Machine learning models can be collectively managed as a group, also referred to as an ensemble, where the machine learning models are used together and may share feature spaces between elements of the models. As such, reference to a machine learning model or machine learning models herein may refer to a combination of multiple machine learning models that are used together, such as operating on the same group of data. Although specific examples are described with respect to types of machine learning models, other machine learning and/or deep learning techniques can be used to implement the features described herein.

In one or more aspects, one or more machine learning models are trained using a joint training process to find correlations between multiple tasks that can be observed and predicted based on a shared set of input data. Further machine learning refinements can be achieved by using a portion of a previously trained machine learning network to further label or refine a training dataset used in training the one or more machine learning models. For example, semi-supervised or self-supervised learning can be used to initially train the one or more machine learning models using partially annotated input data as a training dataset. The partially annotated training dataset may be missing labels on some of the data associated with a particular input, such as missing labels on instrument data. An instrument network learned as part of the one or more machine learning models can be applied to the partially annotated training dataset to add missing labels to partially labeled instrument data in the training dataset. The updated training dataset with at least a portion of the missing labels populated can be used to further train the one or more machine learning models. This iterative training process may result in model size compression for faster performance and can improve overall accuracy by training ensembles. Ensemble performance improvement can result where feature sets are shared such that feature sets related to surgical instruments are also used for surgical phase detection, for example. Thus, improving the performance aspects of machine learning related to instrument data may also improve the performance of other networks that are primarily directed to other tasks.

After training, the one or more machine learning models can then be used in real-time to process one or more data streams (e.g., video streams, audio streams, RFID data, etc.). The processing can include predicting and characterizing one or more surgical phases, instruments, and/or other structures within various instantaneous or block time periods.

The structures can be used to identify a stage within a surgical workflow (e.g., as represented via a surgical data structure), predict a future stage within a workflow, the remaining time of the operation, etc. Workflows can be segmented into a hierarchy, such as events, actions, steps, surgical objectives, phases, complications, and deviations from a standard workflow. For example, an event can be camera in, camera out, bleeding, leak test, etc. Actions can include surgical activities being performed, such as incision, grasping, etc. Steps can include lower-level tasks as part of performing an action, such as first stapler firing, second stapler firing, etc. Surgical objectives can define a desired outcome during surgery, such as gastric sleeve creation, gastric pouch creation, etc. Phases can define a state during a surgical procedure, such as preparation, surgery, closure, etc. Complications can define problems, or abnormal situations, such as hemorrhaging, staple dislodging, etc. Deviations can include alternative routes indicative of any type of change from a previously learned workflow. Aspects can include workflow detection and prediction, as further described herein.

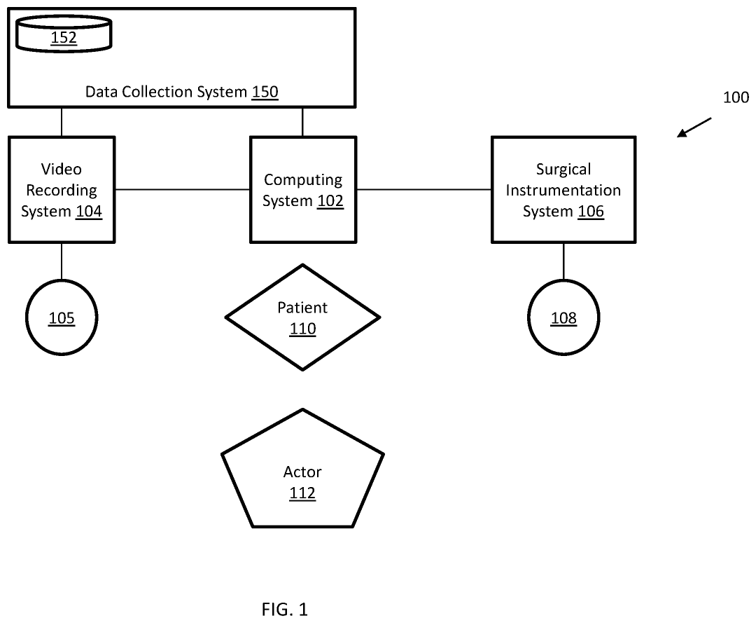

FIG. 1 depicts an example CAS system according to one or more aspects. The CAS system 100 includes at least a computing system 102, a video recording system 104, and a surgical instrumentation system 106.

Actor 112 can be medical personnel that uses the CAS system 100 to perform a surgical procedure on a patient 110. Medical personnel can be a surgeon, assistant, nurse, administrator, or any other actor that interacts with the CAS system 100 in a surgical environment. The surgical procedure can be any type of surgery, such as but not limited to cataract surgery, laparoscopic cholecystectomy, endoscopic endonasal transsphenoidal approach (eTSA) to resection of pituitary adenomas, or any other surgical procedure. The surgical procedure, in some cases, may be a robotic surgery, i.e., actor 112 is a robot, for example, a robotic partial nephrectomy, a robotic prostatectomy, etc. In other examples, actor 112 can be a technician, an administrator, an engineer, or any other such personnel that interacts with the CAS system 100. For example, actor 112 can record data from the CAS system 100, configure/update one or more attributes of the CAS system 100, review past performance of the CAS system 100, repair the CAS system 100, etc.

A surgical procedure can include multiple phases, and each phase can include one or more surgical actions. A “surgical action” can include an incision, a compression, a stapling, a clipping, a suturing, a cauterization, a sealing, or any other such actions performed to complete a phase in the surgical procedure. A “phase” represents a surgical event that is composed of a series of steps (e.g., closure). A “step” refers to the completion of a named surgical objective (e.g., hemostasis). During each step, certain surgical instruments 108 (e.g., forceps) are used to achieve a specific objective by performing one or more surgical actions. As used herein, a “surgical maneuver” can refer to any of a surgical phase, a surgical action, a step, etc.

The surgical instrumentation system 106 provides electrical energy to operate one or more surgical instruments 108 to perform the surgical actions. The electrical energy triggers an activation in the surgical instrument 108. The electrical energy can be provided in the form of an electrical current or an electrical voltage. The activation can cause a surgical action to be performed. The surgical instrumentation system 106 can further include electrical energy sensors, electrical impedance sensors, force sensors, bubble and occlusion sensors, and various other types of sensors. The electrical energy sensors can measure and indicate an amount of electrical energy applied to one or more surgical instruments 108 being used for the surgical procedure. The impedance sensors can indicate an amount of impedance measured by the surgical instruments 108, for example, from the tissue being operated upon. The force sensors can indicate an amount of force being applied by the surgical instruments 108. Measurements from various other sensors, such as position sensors, pressure sensors, flow meters, can also be input.

The video recording system 104 includes one or more cameras, such as operating room cameras, endoscopic cameras, etc. The cameras capture video data of the surgical procedure being performed. The video recording system 104 includes one or more video capture devices that can include cameras placed in the surgical room to capture events surrounding (i.e., outside) the patient being operated upon. The video recording system 104 further includes cameras that are passed inside (e.g., endoscopic cameras) the patient to capture endoscopic data. The endoscopic data provides video and images of the surgical procedure.

The computing system 102 includes one or more memory devices, one or more processors, a user interface device, among other components. The computing system 102 can execute one or more computer-executable instructions. The execution of the instructions facilitates the computing system 102 to perform one or more methods, including those described herein. The computing system 102 can communicate with other computing systems via a wired and/or a wireless network. In one or more examples, the computing system 102 includes one or more trained machine learning models that can detect and/or predict features of/from the surgical procedure that is being performed or has been performed earlier. Features can include structures such as anatomical structures, surgical instruments (108), or other representations of spatial information in the captured video of the surgical procedure. Features can further include surgical phases and actions taken during the surgical procedure. Features that are detected can further include actor 112, patient 110. Based on the detection, the computing system 102, in one or more examples, can provide recommendations for subsequent actions to be taken by actor 112. Alternatively, or in addition, the computing system 102 can provide one or more reports based on the detections. The detections by the machine learning models can be performed in an autonomous or semi-autonomous manner.

The machine learning models can include artificial neural networks, such as deep neural networks, convolutional neural networks, graph networks, recurrent neural networks, encoders, decoders, or any other type of machine learning model. The machine learning models can be trained in a supervised, unsupervised, or hybrid manner. The machine learning models can be trained to perform detection and/or prediction using one or more types of data acquired by the CAS system 100. For example, the machine learning models can use the video data captured via the video recording system 104. Alternatively, or in addition, the machine learning models use the surgical instrumentation data from the surgical instrumentation system 106. In yet other examples, the machine learning models may use any combination of video data and surgical instrumentation data, or other device data captured during the surgical procedure.

Additionally, in some examples, the machine learning models can also use audio data captured during the surgical procedure. The audio data can include sounds emitted by the surgical instrumentation system 106 while activating one or more surgical instruments 108. Alternatively, or in addition, the audio data can include voice commands, snippets, or dialog from one or more actors 112. The audio data can further include sounds made by the surgical instruments 108 during their use.

In one or more examples, the machine learning models can detect surgical actions, surgical phases, anatomical structures, surgical instruments, and various other features from the data associated with a surgical procedure. The detection can be performed in real-time in some examples. Alternatively, or in addition, the computing system 102 analyzes the surgical data, i.e., the diverse types of data captured during the surgical procedure, in an offline manner (e.g., post-surgery). In one or more examples, the machine learning models detect surgical maneuvers based on detecting some of the features such as the anatomical structure, surgical instruments, etc.

A data collection system 150 can be employed to store the surgical data. In some aspects, “surgical data” of a surgical procedure is a set of all captured data for the surgical procedure synchronized to a captured video of the surgical procedure being performed. The surgical data P={video, video-synchronized data, procedure data}. Here, the video captures the surgical procedure; video-synchronized data includes device data (e.g., energy profiles, surgical instrument activation/deactivation, etc.); and procedure data includes metadata of the surgical procedure (e.g., surgeon identification and demographic information, patient identification and demographic information, hospital identification and demographic information, etc.). The surgical data P can include additional information in some aspects. In some examples, an electronic medical record of the patient can be used to populate the surgical data.

The data collection system 150 includes one or more storage devices 152. The data collection system 150 can be a local storage system, a cloud-based storage system, or a combination thereof. Further, the data collection system 150 can use any type of cloud-based storage architecture, for example, public cloud, private cloud, hybrid cloud, etc. In some examples, the data collection system can use distributed storage, i.e., the storage devices 152 are located at different geographic locations. The storage devices 152 can include any type of electronic data storage media used for recording machine-readable data, such as semiconductor-based, magnetic-based, optical-based storage media, or a combination thereof. For example, the data storage media can include flash-based solid-state drives (SSDs), magnetic-based hard disk drives, magnetic tape, optical discs, etc.

In one or more examples, the data collection system 150 can be part of the video recording system 104, or vice-versa. In some examples, the data collection system 150, the video recording system 104, and the computing system 102, can communicate with each other via a communication network, which can be wired, wireless, or a combination thereof. The communication between the systems can include the transfer of data (e.g., video data, instrumentation data, etc.), data manipulation commands (e.g., browse, copy, paste, move, delete, create, compress, etc.), data manipulation results, etc. In one or more examples, the computing system 102 can manipulate the data already stored/being stored in the data collection system 150 based on outputs from the one or more machine learning models, e.g., phase detection, structure detection, etc. Alternatively, or in addition, the computing system 102 can manipulate the data already stored/being stored in the data collection system 150 based on information from the surgical instrumentation system 106.

In one or more examples, the video captured by the video recording system 104 is stored on the data collection system 150. In some examples, the computing system 102 curates parts of the video data being stored on the data collection system 150. In some examples, the computing system 102 filters the video captured by the video recording system 104 before it is stored on the data collection system 150. Alternatively, or in addition, the computing system 102 filters the video captured by the video recording system 104 after it is stored on the data collection system 150.

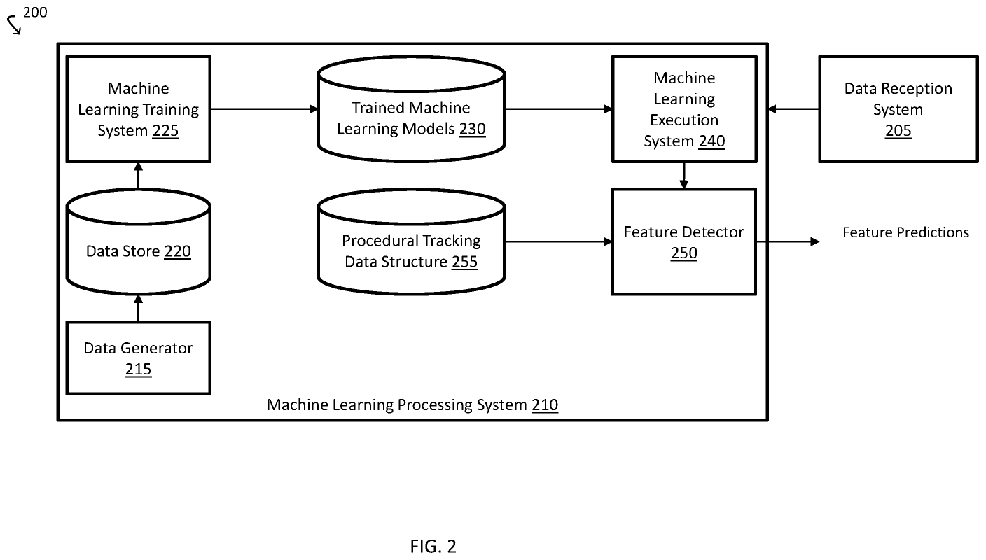

FIG. 2 shows a system 200 for analyzing the video captured by the video recording system according to one or more aspects. The analysis can result in predicting surgical features (e.g., phases, instruments, anatomical structures, etc.) in the video data using machine learning. The system 200 can be the computing system 102, or a part thereof in one or more examples. In some aspects, the computing system 102 is part of the system 200. System 200 uses data streams in the surgical data to identify procedural states according to some aspects.

System 200 includes a data reception system 205 that collects surgical data, including the video data and surgical instrumentation data. The data reception system 205 can include one or more devices (e.g., one or more user devices and/or servers) located within and/or associated with a surgical operating room and/or control center. The data reception system 205 can receive surgical data in real-time, i.e., as the surgical procedure is being performed. Alternatively, or in addition, the data reception system 205 can receive or access surgical data in an offline manner, for example, by accessing data that is stored in the data collection system 150.

System 200 further includes a machine learning processing system 210 that processes the surgical data using one or more machine learning models to identify one or more features, such as surgical maneuvers, instrument, anatomical structure, etc., in the surgical data. It will be appreciated that machine learning processing system 210 can include one or more devices (e.g., one or more servers), each of which can be configured to include part or all of one or more of the depicted components of the machine learning processing system 210. In some instances, a part or all of the machine learning processing system 210 is in the cloud and/or remote from an operating room and/or physical location corresponding to a part or all of data reception system 205. It will be appreciated that several components of the machine learning processing system 210 are depicted and described herein. However, the components are just one example structure of the machine learning processing system 210, and that in other examples, the machine learning processing system 210 can be structured using a different combination of the components. Such variations in the combination of the components are encompassed by the technical solutions described herein.

The machine learning processing system 210 includes a machine learning training system 225, which can be a separate device (e.g., server) that stores its output as one or more trained machine learning models 230. The machine learning models 230 are accessible by a model execution system 240. The model execution system 240 can be separate from the machine learning training system 225 in some examples. In other words, in some aspects, devices that “train” the models are separate from devices that “infer,” i.e., perform real-time processing of surgical data using the trained machine learning models 230.

Machine learning processing system 210, in some examples, further includes a data generator 215 to generate simulated surgical data, such as a set of virtual images, or record the video data from the video recording system 104, to train the machine learning models 230. Data generator 215 can access (read/write) a data store 220 to record data, including multiple images and/or multiple videos. The images and/or videos can include images and/or videos collected during one or more procedures (e.g., one or more surgical procedures). For example, the images and/or video may have been collected by a user device worn by the actor 112 (e.g., surgeon, surgical nurse, anesthesiologist, etc.) during the surgery, a non-wearable imaging device located within an operating room, or an endoscopic camera inserted inside the patient 110. The data store 220 is separate from the data collection system 150 in some examples. In other examples, the data store 220 is part of the data collection system 150.

Each of the images and/or videos recorded in the data store 220 for training the machine learning models 230 can be defined as a base image and can be associated with other data that characterizes an associated procedure and/or rendering specifications. For example, the other data can identify a type of procedure, a location of a procedure, one or more people involved in performing the procedure, surgical objectives, and/or an outcome of the procedure. Alternatively, or in addition, the other data can indicate a stage of the procedure with which the image or video corresponds, rendering specification with which the image or video corresponds and/or a type of imaging device that captured the image or video (e.g., and/or, if the device is a wearable device, a role of a particular person wearing the device, etc.). Further, the other data can include image-segmentation data that identifies and/or characterizes one or more objects (e.g., tools, anatomical objects, etc.) that are depicted in the image or video. The characterization can indicate the position, orientation, or pose of the object in the image. For example, the characterization can indicate a set of pixels that correspond to the object and/or a state of the object resulting from a past or current user handling. Localization can be performed using a variety of techniques for identifying objects in one or more coordinate systems.

The machine learning training system 225 uses the recorded data in the data store 220, which can include the simulated surgical data (e.g., set of virtual images) and actual surgical data to train the machine learning models 230. The machine learning model 230 can be defined based on a type of model and a set of hyperparameters (e.g., defined based on input from a client device). The machine learning models 230 can be configured based on a set of parameters that can be dynamically defined based on (e.g., continuous, or repeated) training (i.e., learning, parameter tuning). Machine learning training system 225 can use one or more optimization algorithms to define the set of parameters to minimize or maximize one or more loss functions. The set of (learned) parameters can be stored as part of a trained machine learning model 230 using a specific data structure for that trained machine learning model 230. The data structure can also include one or more non-learnable variables (e.g., hyperparameters and/or model definitions).

Machine learning execution system 240 can access the data structure(s) of the machine learning models 230 and accordingly configure the machine learning models 230 for inference (i.e., prediction). The machine learning models 230 can include, for example, a fully convolutional network adaptation, an adversarial network model, an encoder, a decoder, or other types of machine learning models. The type of the machine learning models 230 can be indicated in the corresponding data structures. The machine learning model 230 can be configured in accordance with one or more hyperparameters and the set of learned parameters.

The machine learning models 230, during execution, receive, as input, surgical data to be processed and subsequently generate one or more inferences according to the training. For example, the video data captured by the video recording system 104 can include data streams (e.g., an array of intensity, depth, and/or RGB values) for a single image or for each of a set of frames (e.g., including multiple images or an image with sequencing data) representing a temporal window of fixed or variable length in a video. The video data that is captured by the video recording system 104 can be received by the data reception system 205, which can include one or more devices located within an operating room where the surgical procedure is being performed. Alternatively, the data reception system 205 can include devices that are located remotely, to which the captured video data is streamed live during the performance of the surgical procedure. Alternatively, or in addition, the data reception system 205 accesses the data in an offline manner from the data collection system 150 or from any other data source (e.g., local, or remote storage device).

The data reception system 205 can process the video data received. The processing can include decoding and/or decompression when a video stream is received in an encoded or compressed format such that data for a sequence of images can be extracted and processed. The data reception system 205 can also process other types of data included in the input surgical data. For example, the surgical data, as part of the device data, can include additional non-video data streams, such as audio data, RFID data, textual data, measurements from one or more surgical instruments/sensors, etc., that can represent stimuli/procedural states from the operating room. The data reception system 205 synchronizes the different inputs from the different devices/sensors before inputting them in the machine learning processing system 210.

The machine learning models 230, once trained, can analyze the input surgical data, and in one or more aspects, predict and/or characterize features included in the video data included in the surgical data. The video data can include sequential images and/or encoded video data (e.g., using digital video file/stream formats and/or codecs and containers, such as MP4, H.264, MOV, WEBM, AVCHD, OGG, etc.). The prediction and/or characterization of the features can include segmenting the video data or predicting the localization of the structures with a probabilistic heatmap. In some instances, the one or more machine learning models include or are associated with a preprocessing or augmentation (e.g., intensity normalization, resizing, cropping, etc.) that is performed prior to segmenting the video data. An output of the one or more machine learning models can include image-segmentation or probabilistic heatmap data that indicates which (if any) of a defined set of features are predicted within the video data, a location and/or position and/or pose of the features(s) within the video data, and/or state of the features(s). The location can be a spatial position, such as a set of coordinates in an image/frame in the video data. For example, the coordinates can provide a bounding box. The coordinates can provide boundaries that surround the structure(s) being predicted. Alternatively, or in addition, the location can be a temporal location in the stream, such as a portion of the stream that represents a particular surgical phase, a starting timepoint of the surgical phase, an ending timepoint of the surgical phase, etc. The machine learning models 230, in one or more examples, are trained to perform higher-level predictions and tracking, such as predicting a phase of a surgical procedure and tracking one or more surgical instruments used in the surgical procedure.

While some techniques for predicting surgical features, structures, and maneuvers in the surgical procedure are described herein, it should be understood that any other technique for such prediction can be used without affecting the aspects of the technical solutions described herein. In some examples, the machine learning processing system 210 includes a feature detector 250 that uses the machine learning models to identify features within the surgical procedure (“procedure”).

The feature detector 250 outputs the feature prediction associated with a portion of the video data that is analyzed by the machine learning processing system 210. The feature prediction is associated with the portion of the video data by identifying a start time and an end time of the portion of the video that is analyzed by the machine learning execution system 240. The feature prediction that is output can include an identity of a surgical phase as detected by the feature detector 250 based on the output of the machine learning execution system 240. Further, the feature prediction, in one or more examples, can include identities of the structures (e.g., instrument, anatomy, etc.) that are identified by the machine learning execution system 240 in the portion of the video that is analyzed. The feature prediction can also include a confidence score of the prediction. Other examples can include various other types of information in the feature prediction that is output.

The development of intelligent context-aware CAS 100 significantly improves the safety and quality of modern operating rooms (ORs). Particularly, by using system 200 as (or as part of) such CAS 100, recognition of surgical phases enables partitioning complex surgical procedures into well-defined surgical steps and more granular analysis of surgical workflows. This paves the way towards standardization of surgical workflows and identification of best practices, providing intraoperative context-aware assistive information, and improving team coordination in the OR. Surgical workflow recognition, which includes surgical phase recognition, has therefore become an active field of research. Most of the effort has been focused on vision-based approaches as videos are less invasive to collect, and moreover, videos are inherently available in case of minimally invasive surgery. However, a robust and efficient video-based surgical phase recognition is a technical challenge considering the large amount of data that has to be analyzed, the unique challenges of computer vision, with added technical challenges of detecting surgery-specific features such as anatomy and instruments.

Technical solutions described herein facilitate segmenting a surgical video into surgical phases, each surgical phase includes a subset of the video frames from the surgical video. Segmenting the surgical video includes identifying the subset of the video frames that represent a particular surgical phase.

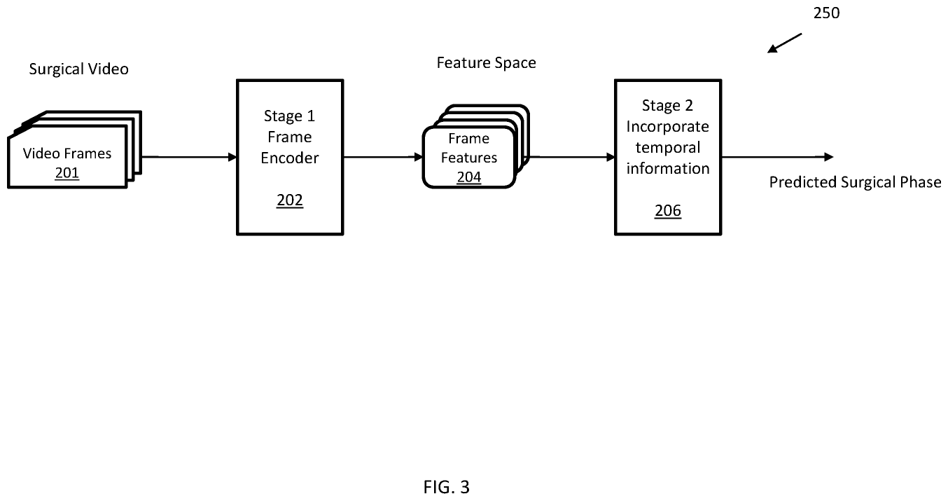

FIG. 3 depicts a block diagram of video-based phase recognition being performed using machine learning according to one or more examples. The video-based phase recognition can be performed by the system 200, and particularly by the feature detector 250. The surgical phase detection is performed on an input video stream of a surgical procedure, which is received, for example, from an endoscopic camera. The video-based phase recognition predicts a surgical phase in the input video stream that is captured. As the input video stream changes (e.g., different actions are performed in the surgical procedure), the predicted surgical phase can also change (depending on the action being performed).

The video-based feature recognition uses two-stage machine learning models. The first stage 202 relies on an encoder to build robust vector representations for video frames 201 in the input video. Here, a “video frame” (or frame) 201 can be an image that is part of a sequence of images that are played back at the desired rate, for example, 30 frames per second, 60 frames per second, etc. so that the sequence of images is viewed as a motion picture, i.e., “video.” The encoder generates frame features 204 corresponding respectively to the frames 201 from the input video. Each frame feature 204 is a latent representation of the corresponding video frame 201. The frame feature 204 can be represented as vectors, matrices, or in any other form or data structure. Generally, the encoder is a machine learning model, for example, which uses either two-dimensional (2D) convolutional models such as residual network (ResNet) and Squeeze-and-Excitation Network (SENet), or 3D convolutional models, like I3D. Aspects of the technical solutions described herein can be implemented using any techniques known now or developed later to build robust representations for video frames. Such models provide task-specific models to map RGB frames/images 201 (from the video) into frame features 204 in the robust feature space.

In the second stage 206, the encoded representations, i.e., frame features 204, from the first stage 202 are fed into a decoder to incorporate temporal information and predict phases. Typically, to incorporate such temporal information, the second stage 206 is implemented as long short-term memory (LSTM) machine learning models, temporal convolutional networks (TCN), or a combination thereof. However, typical models used for the second state 206 pose various limitations and performance-related challenges.

Technical solutions are described herein to address such technical challenges in the second stage 206 of the video-based surgical phase recognition system 200. The technical solutions described herein use graph neural networks (GNNs) to implement the second stage 206. A temporal graph is defined over a video where nodes are video frames and edges connect nodes that are temporally adjacent. Message passing is used to incorporate information from neighboring frames and updates nodes internal state. A GNN-based temporal decoder has several advantages. Firstly, the graph structure allows to precisely define temporal neighborhood hence removing the need for using multiple layers and stages unlike TCNs. Secondly, information from all temporally connected frames is accessible during the update process of each node. This is in contrast to LSTM that build a memory state and update the memory at each time step. Thirdly, as the temporal aggregation function and node state update function are shared among all nodes, such a model has much lower number of parameters compared to transformer-based models. This is especially important in case of surgical phase recognition due to scarcity of data.

Temporal aggregating can happen in different order and thus it does not have any notion of frames' 201 temporal positions, which is important to disambiguate distinct phases. In one or more aspects, positional information is encoded as edge attribute. Encoding positions are important to effectively build and use temporal context. A series of experiments on datasets, such as the Cholec80 dataset and compared with state-of-the-art models show that the model described by the aspects herein successfully incorporates temporal context for building robust models and outperforms the state-of-the-art models.

In computer science, a graph is a data structure consisting of two components, nodes (or vertices) and edges, i.e., the graph G is a set of nodes V and edges E that indicate node adjacency. Edges can be either directed or undirected, depending on whether there exist directional dependencies between nodes.

A GNN is a type of neural network which directly operates on the graph data structure and is a class of neural networks designed to represent data in a structured manner using graphs.

In one or more examples of the technical solutions described herein, the GNN used to implement the second stage 206 models the input video stream as the graph G (N, E) where each node represents a video frame 201 in the video (in feature space) and each edge indicates temporal neighborhood among nodes, i.e., video frames 201. In contrast to typically used models like LSTM and TCN, using GNN precisely defines temporal neighborhoods via graph edges. The neighborhood map can be defined across frames that are temporally more distant compared to TCN models that require deep multilayer models to incorporate temporally distant frames. Further, to facilitate the use of relative temporal frame information that is lost due to the use of neighborhood aggregation functions in GNN, the technical solutions described herein use positional information via edge attributes. By making such adjustments, technical solutions described herein facilitate using graph network models for building neighborhoods across a video and extending it with positional information.

The technical solutions described herein provide autonomous surgical phase recognition and positional encoding for considering relative temporal distance among nodes using a GNN based machine learning model. Using GNN results in a performance boost in surgical phase recognition by the system 200. The performance boost includes an increase in speed of the phase recognition, enabling a more real-time operation. Further, using GNN also provides a more elegant formation.

Graphs can be of arbitrary topology, and thus, makes this a very flexible representation that can encode a variety of spatio-temporal relationships. GNNs offer to model problems using spectral graph theory and generalize convolutions to non-Euclidean data for different tasks, such as classification and regression. This is achieved by a differentiable implementation of message passing that enables exchanging vector messages between nodes in a graph through a form of belief propagation and utilizing neural networks for updating messages and node embedding.

Each node vᵢ∈V is represented by a feature vector xᵢ∈R^{D}. In some aspects, D can be configurable to, for example, 2048, 4096, or any other value. The edges define neighborhood over the graph, which are used to aggregate information. Message passing or neighborhood aggregation is defined as:

$${x}_{i}^{k + 1} = {f}^{k} ( {x}_{i}^{k} , {Agg}_{j ∈ N ( i )} {g}^{k} ( {x}_{i}^{k} , {x}_{j}^{k} ) ) \qquad ( 1 )$$

Here, f and g are differentiable equations, i.e., neural networks; and Agg is a permutation invariant and differentiable function. During each iteration of the message passing, the embedding xᵢ is updated according to the aggregated information from vᵢ's neighborhood denoted by N(i). As the iterations progress, each node will have access to information from further away nodes. For example, after the second iteration, i.e., second layer, each node contains information from nodes that are reachable by a path of maximum length of 2 in the graph.

The message passing facilitates incorporating information from neighboring nodes. The technical solutions described herein, define a temporal graph over a video and rely on message passing to aggregate and incorporate temporal context. The temporal graph enables aspects of the technical solutions herein to precisely define the temporal neighborhood by constructing the topology of the selected graph and in turn to encode known procedural information. But as the aggregation function is permutation invariant and also does not preserve frame position in the video, all direct neighbors contribute to the node in the same way. This is not a desired behavior for a temporal graph as variation in temporal distance between frames should affect how a frame contributes to the context of another frame. One solution is to build the graph in way that only nodes with the same temporal distance are connected. Each frame is connected only to the next frame in case of online phase recognition. Increasing temporal context would imply adding more layers for more massage passing iterations hence expanding the neighborhood by the number of layers. For example, for a neighborhood of 60 seconds over a 1 FPS video, 60 layers will be required. This results in adding more parameters and limited ability in defining the graph.

To mitigate these issues, technical solutions described herein facilitate a position-aware temporal graph (PATG) data structure. PATG allows encoding frames positions and utilize them during the message passing process to more accurately use neighbors to update node embedding.

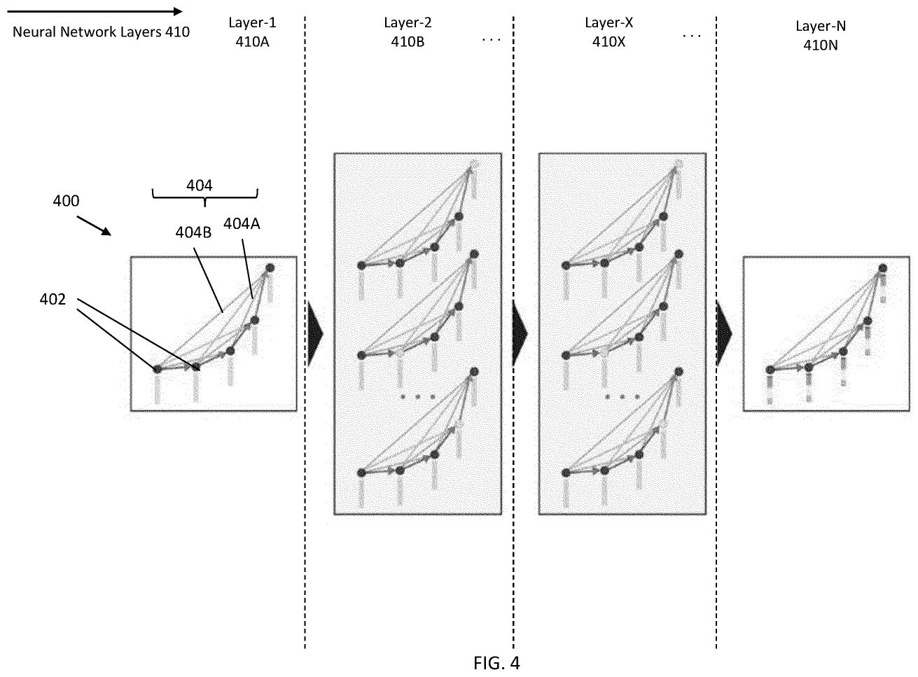

FIG. 4 depicts an example position-aware temporal graph according to one or more aspects. Each node 402 in the graph 400 denotes a frame 201 (and/or frame feature 204) from the input video. Frame relative position is encoded on the edges 404. For example, edge 404A can denote a onetime step, and an edge 404B can denote 4 time steps. In some aspects, the PATG 400 can be visualized, where the edges 404 are denoted by distinct color here, e.g., blue for the edge 404A with one time step and green for the edge 404B with 4 time steps. Other visual attributes can be used in other examples.

During message passing from one layer 410 of the neural network to the next, each node 402 (highlighted in FIG. 4), aggregates information from all its neighboring nodes 402 and updates its embedding. An “embedding” is a representation of information at each node 402. In some aspects, the embedding associated with a node 402 reduces the dimensionality of the data represented by that node 402. Embeddings can take all that information associated with the node 402 and translate it into a single, meaningful vector that encodes the nodes 402, their properties, their relationships to neighbors, and their context in the entire graph 400. In other words, an “embedding” of the node 402 is a vector in some aspects. The vector is based on latent representations of the frame features 204 mapped to the node 402.

Because an online phase recognition (i.e., real-time phase recognition as video is being captured/streamed) is desired, a directed graph is used to connect past frames to the current (i.e., present) frame in the PATG 400. It should be noted that aspects described herein are also applicable for recognizing surgical phases by analyzing videos that are already captured and stored. Temporal edges 404 are grouped based on their corresponding path length. A positional encoding function is used to inject frame positions during message passing iterations. For example:

$${x}_{i}^{k + 1} = {f}^{k} ( {x}_{i}^{k} , {Agg}_{j ∈ N ( i )} {g}^{k} ( {x}_{i}^{k} , {x}_{j}^{k} , {P}_{i , j} ) ) \qquad ( 2 )$$

Here, P_{i,j} is a function to encode frame positions in the embeddings of the nodes 402. In some aspects, the positional encoder can be defined as:

$${P}_{i , j}^{2 l} = sin ( \frac{i - j}{{10000}^{2 l / d}} ) , {P}_{i , j}^{2 l + 1} = cos ( \frac{i - j}{{10000}^{2 l / d}} ) \qquad ( 3 )$$

where l∈[0, d/2] and d is the positional encoding dimension. The positional encoding dimension (d) can be predefined. The message from vⱼ to vᵢ is computed based on their embeddings and positions in the video. The function g determines this relationship, which is learned through backpropagation. Accordingly, the graph 400 can be defined that connects frames 206 from various parts of a video and rely on the neural network g to take the temporal context into account and compute update message for each node 402.

After message passing iterations, updated node embeddings are used to predict phase labels. The phase labels are generated using computer vision/deep learning. The number of layers 410 can vary in the one or more aspects of the technical solutions herein. It is also appreciated that the structure, the number of nodes 402, and/or the number of edges 404 of the graph 400 can vary in the one or more aspects.

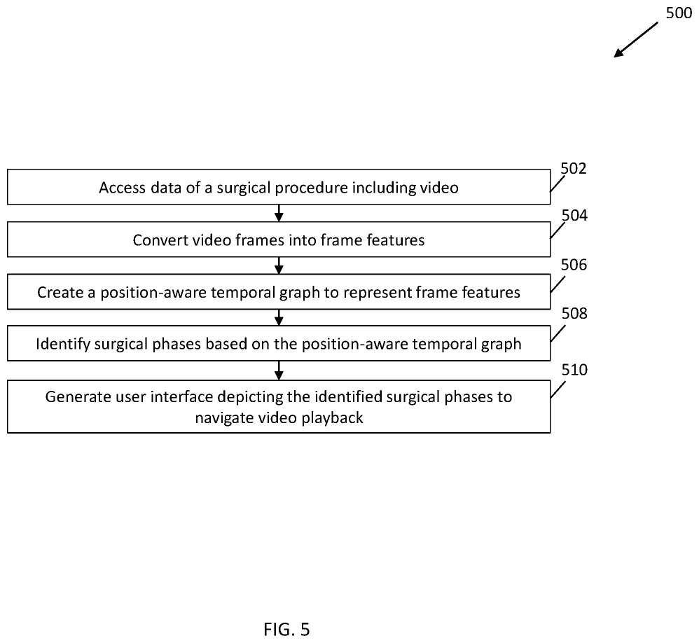

FIG. 5 depicts a flowchart of a method 500 for surgical phase recognition (phase recognition) in a surgical video (video) using machine learning models utilizing a position aware temporal graph according to one or more aspects. Method 500 is a computer-implemented method that can be executed by one or more systems described herein, for example system 100 of FIG. 1. Method 500 includes using the machine learning processing system 210 to detect, predict, and track features, including the surgical phases. It should be understood that the sequence of operations depicted in FIG. 5 is exemplary, and that the depicted operations can be performed in a different order, or in parallel in some aspects.

At block 502, system 100 can access input data, including, for example, video data of a surgical procedure from a surgical camera. The surgical camera can be an endoscopic/laparoscopic camera. The video data (video) can be accessed in a digital/electronic format such as a file, a stream, etc., or a combination thereof. The input data, in some aspects, can further include sensor data temporally associated with the video. The input data can be accessed in an online manner (real-time, as the procedure is being performed) or in an offline manner (post-surgery), for example, from the data collection system 150. In one or more examples, accessing the input data includes receiving or accessing one or more portions of the video of a surgical procedure. In some examples, the video is transmitted to the data reception system 205 as a video stream in real-time as the surgical procedure is being performed. This transmission may occur using any variety of video compression and container technology and streaming protocols (e.g., HTTP, RTMP, etc.). The transmission can be wired, or wireless. In some aspects, the data reception system 205 stores the video for the processing by the method 500.

At block 504, the frame encoder 202 extracts high-level concise representations of the video frames 201 in the video and generates corresponding frame features 204. The frame encoder 202 is a machine learning model, such as using a convolutional network. In some aspects, the frame encoder 202 is structured as a ResNet50 convolutional network.

The frame encoder 202 generates the frame features 204 by projecting the video-frames 201 (e.g., RGB frames) from the input video into a high-dimensional feature space. For example, the last fully connected layer of the frame encoder 202 is used to extract 2048-dimension feature vectors, where each vector represents a respective video-frame. The latent representation is based on the weight values, and other hyper parameters of the trained frame encoder 202. The trained frame encoder 202 encodes spatial-temporal video information from the video frame 201 into the latent representation frame feature 204. The vector representation is based on a predetermined dimension assigned to each frame feature, e.g., 2048. In some aspects,

In some aspects, the frame encoder 202 is trained to recognize the phases using only phase annotations in the training data, and without any other annotations. For example, if a dataset such as the Cholec80 video database is used for training the frame encoder 202, the other annotations (e.g., instrument labels) provided by the dataset are not used when training the frame encoder 202. It should be noted that the machine learning models are trained at an earlier time (prior to execution of method 500, for example).

In some aspects, in addition to the spatial-temporal information in the video frame 201, the latent representation can also be based on the other data stored in the surgical data. For example, the device information (e.g., energy information, instrument information, etc.) and surgical procedure metadata can be used to generate the frame features 204. In some aspects, the frame features 204 (which represents the feature space, or latent representation space) are stored for further analysis.

Accordingly, by computing the frame features 204 for each video frame 201 in the video, the video can be represented in the latent representation as a collection of frame features 204, <L1, L2, . . . Ln>, where Li represents the frame feature 204 of the ith video frame 201 in the video.

At block 506, a position-aware temporal graph (400) is created for the frame features 204. Unlike recurrent neural networks and temporal convolution networks, graph-based approach offers a more generic and flexible way for modeling temporal relationships. Each frame feature 204 is a node 402 in the PATG 400 and the edges 404 in the PATG 400 are used to define temporal connections among the nodes 402. The flexible configuration of temporal neighborhood comes at the price of losing temporal order. To mitigate this, the PATG 400 created to take temporal orders into account by encoding frame positions (i.e., sequence/order of frames 204 in the video), to reliably predict surgical phases. In some aspects, a directed graph is used to connect past frames to the current frame in the PATG 400.

In some aspects, the PATG 400 is created using a GNN to incorporate the temporal information (206). The PATG 400 is created as described elsewhere herein. The GNN used to create the PATG 400 is a temporal decoder (206). In some aspects, the temporal decoder architecture includes three blocks. In some aspects, the first block includes a series of feature calibration layers (e.g., convolution layers, activations, etc.). In some aspects, the first block is a one convolutional layer followed by a non-linearity ReLU function. Other structures are possible for the first block. The first block is responsible for reducing encoder representation to the dimension of the node embeddings F. The second block has n layers of graph convolutions. Some aspects use principal neighborhood aggregation (PNA) layers as graph convolution. While, PNA has demonstrated significant improvement over most of graph convolutions on different benchmark from real-world domains by combining multiple aggregators and degree-based scalars, other techniques can be used in one or more aspects. The last block is classification head that first reduces the node dimension to half, which is followed a ReLU (another ReLU) and finally a fully connected layer of the size of the output classes. The structure described above is exemplary, and the one or more blocks described above can be combined or further separated in one or more aspects.

In some aspects, the node embedding dimension (F) is predefined to a value such as, 256, 512, etc. In some aspects, the PNA graph convolution layers use min, max, mean, and STD aggregation functions, and identity, attenuation, and amplification as degree-based scalars. The number of graph convolutional layers, n, can be preconfigured, for example, to four, six, etc. The positional encoding dimension, d, can be set to an integer value, like 32, 64, etc.

The GNN can be implemented using any programming language, programming libraries, and/or application programming interface. For example, PyTorch Geometric can be used to implement the model, with the Adam optimizer with a learning rate of 0.0001 and a weight decay of 1e⁻⁵. The dropout for the graph convolution layers can be set to 0.2. It is noted that the above settings are exemplary, and other setting values can be used in one or more aspects.

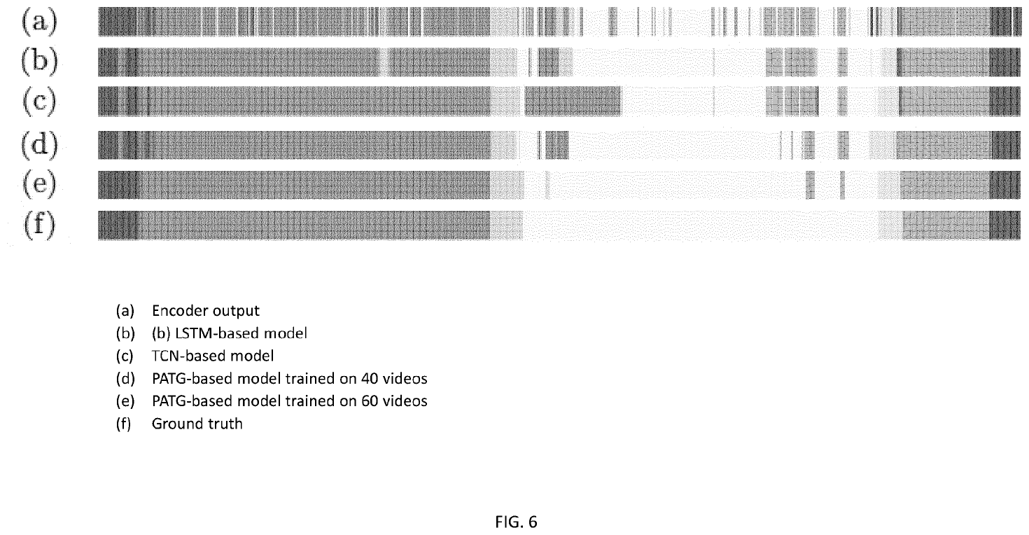

The GNN based approach takes into account the temporal aspects across the length of the video, facilitating to precisely define the neighborhood based on the problem and dataset size. A comparison with state-of-the-art models indicates that the aspects described herein provide an improved model across all of the metrics: accuracy, precision, recall, and F1 score. Further, such improved results can be obtained even with a limited number of samples for training the GNN model in comparison to training required in state-of-the-art models. Accordingly, PATG incorporates frame positions to more effectively utilize the temporal context compared to state-of-the-art models. FIG. 6 depicts comparison of experimental results of recognizing surgical phases across a video using different techniques. The models (d) and (e) provide the results of the PATG-based model described herein trained with different number of training videos, respectively. The models (a), (b), and (c) provide results of other state-of-the-art models. It should be noted that the depicted results are from an example experimental setup, and that the results can vary in other aspects.

Referring to the flowchart of method 500, at block 508, the temporal information incorporated with the surgical video in the form of the PATG 400 is used to identify the surgical phases in the surgical video. Each frame feature 204 is analyzed to identify the surgical phase represented in that frame feature 204. Such analysis and identification can be performed using one or more techniques of image recognition/classification which are known, or will be developed. All the nodes 402 in the PATG 400 that are temporally connected (by edges 404), are in a sequence, and have the same phase identified in the corresponding frame features 204, are deemed to represent a single surgical phase. In some aspects, the timepoints (i.e., positions) of the frame features in the surgical video are identified and stored along with the surgical video. In some cases, the information about the identified timepoints for the surgical phases is stored in the video file itself (e.g., as part of metadata, header, etc.). Alternatively, or in addition, the information about the identified timepoints for the surgical phases is stored in a separate location from the video data (i.e., video frames 201), for example, in a separate file, database, electronic medical record, etc.

At block 510, the identified surgical phases are depicted via a user interface. The surgical phases that are identified can be used to navigate the surgical video post-operatively, in some aspects.

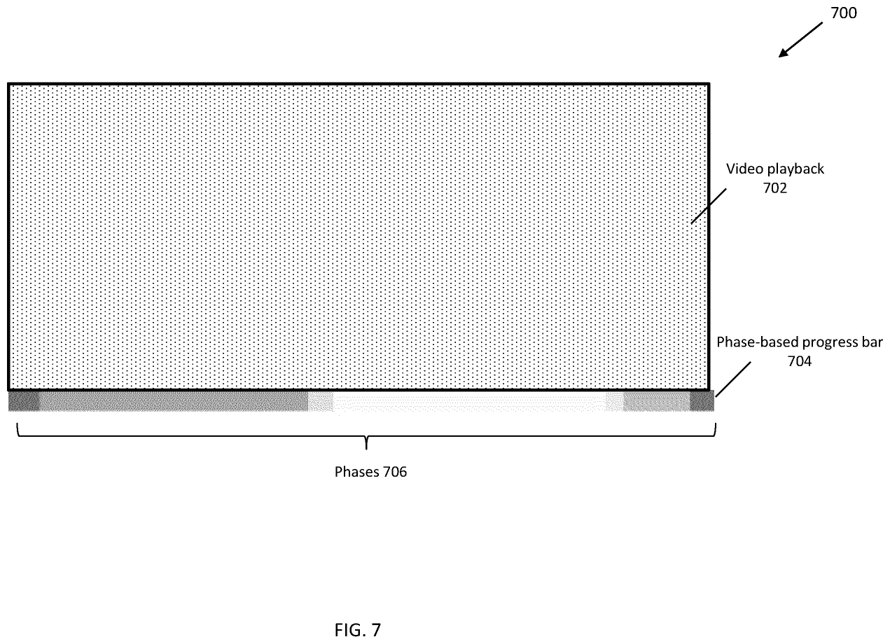

FIG. 7 depicts a user interface for representing surgical phases automatically recognized in a surgical video using machine learning according to one or more aspects. The user interface 700 can be used intra-operatively or post-operatively. The user interface 700 includes a video playback portion 702 and a phase-based progress bar 704. The video playback portion 702 displays the surgical video. The phase-based progress bar 704 enables a user to navigate to different timepoints in the surgical video that is being displayed. The phase-based progress bar 704 displays each identified phase using a respective visual attribute, such as color, gradient, transparency, icons, etc., or a combination thereof.

The user can select a certain phase 706 and navigate the video playback to a starting timepoint of that phase in the video 702. For example, the user can select a phase 706 using an input such as a click, key-press, touch, voice command, etc.

The phase-based progress bar 704 is updated in real-time as the video is being captured. In such cases, the phase-based progress bar 704 keeps changing as the video is analyzed and the incoming frames are categorized into one or more phases 706. For example, consider an example scenario, where first 200 frames have been captured so far. The first 200 frames are all categorized as a first phase. In this case, the phase-based progress bar 704 is all displayed using a first attribute (e.g., color) representing the first phase 706. Now, second 200 frames have been captured. Say, 150 of the second 200 frames are categorized into a second phase 706, and the remaining 50 are categorized into a third phase 706. The phase-based progress bar 704 is now updated with three divided sections—a first section for the first phase 706 (first 200 frames), a second section for the second phase 706 (next 150 frames), and a third section for the third phase 706 (next 50 frames). Each section is shown with a different visual attribute. The phase-based progress bar 704 continues to be updated as additional frames 201 are captured and categorized.

During a post-operative playback of a video, in some aspects, the phase-based progress bar 704 may be generated by executing the method 500 on the video requested for playback. In other aspects, the phase-based progress bar 704 may be generated based on the surgical phase information that may be stored previously, for example, when the video was captured, or a previous playback. The surgical phase information may be accessed from the metadata or header of the video, for example.

Surgical workflow recognition is a fundamental block in developing context aware supporting systems to assist clinical team(s). The GNN-based approach for surgical phase recognition in surgical videos, such as laparoscopic videos, provides an improvement to such supporting systems. Such a system can be used intra-operatively or post-operatively. Aspects of the technical solutions described herein provide a position-aware temporal graph (PATG) to precisely define temporal neighborhood and incorporate frame locations of identified features in a surgical video. Encoded frame positions are used during the message passing process enabling the use of large temporal neighborhood. Accordingly, aspects of the technical solutions described herein facilitates to effectively build and utilize long-term temporal context for robust surgical phase recognition. Experimental results also show that the PATG model provides improved performance, if not at least achieved state-of-the-are result when compared with publicly available datasets.

Accordingly, GNN-based models for surgical phase recognition by constructing temporal graphs over surgical videos, as described herein provide improvements to systems, like CAS systems. In addition, the aspects described herein provide a practical application of machine learning and the improvements to machine learning based in the field of CAS systems. Further, the technical solutions described herein facilitate improvements to computing technology, particularly computing techniques used for machine learning, computer vision, and recognition of features like phases from video data.

Aspects of the technical solutions described herein facilitate one or more machine learning models, such as computer vision models, to process images obtained from a video of the surgical procedure using spatial-temporal information. The machine learning models using techniques such as neural networks to use information from the video and (if available) robotic sensor platform to predict one or more features, such as surgical phases of the surgical procedure. The aspects described herein further facilitate generating a user interface to depict the identified surgical phases and facilitate efficient playback of the surgical video based on the identified surgical phases. Such playback improves efficiency of a user, such as a surgeon, trainee, administrator, patient, etc., who is watching the surgical video.

It should be noted that although some of the drawings depict endoscopic/laparoscopic videos being analyzed, the technical solutions described herein can be applied to analyze video and image data captured by cameras that are not endoscopic (i.e., cameras external to the patient's body) when performing open surgeries (i.e., not laparoscopic surgeries). For example, the video and image data can be captured by cameras that are mounted on one or more personnel in the operating room, e.g., surgeon. Alternatively, or in addition, the cameras can be mounted on surgical instruments, walls, or other locations in the operating room.

The reports/views/annotations and other information described herein is added to an electronic medical record (EMR) in one or more cases. In some aspects, the information about specific surgical procedures can be stored in the patient record associated with the patient that was operated upon during the surgical procedure. Alternatively, or in addition, the information is stored in a separate database for later retrieval. The retrieval can be associated with the patient's unique identification, such as EMR-identification, social security number, or any other unique identifier. The stored data can be used to generate patient-specific reports. In some aspects, information can also be retrieved from the EMR to enhance one or more operations described herein. In one or more aspects, an operational note may be generated, which includes one or more outputs from the machine learning models. The operational note may be stored as part of the EMR.

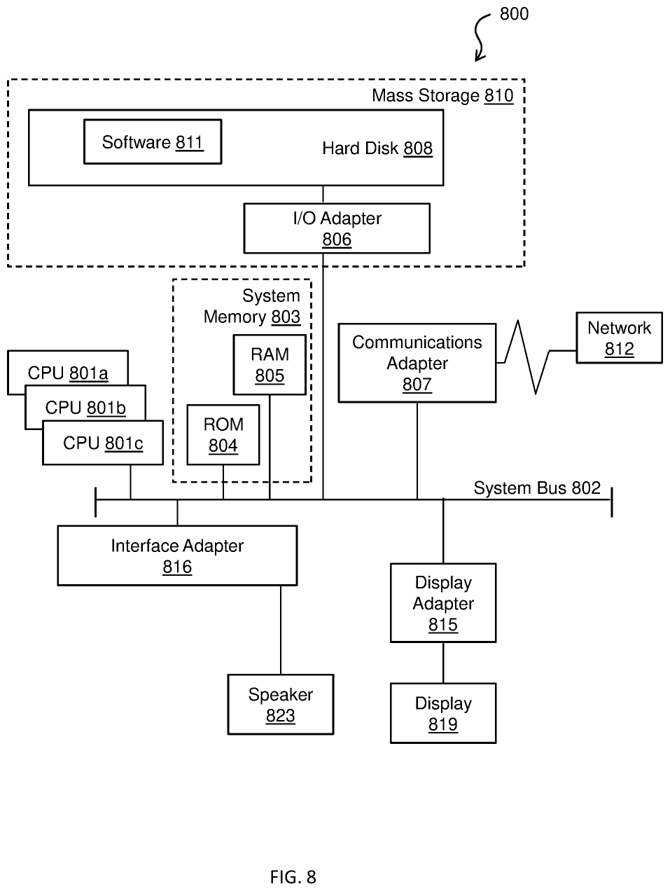

Turning now to FIG. 8, a computer system 800 is generally shown in accordance with an aspect. The computer system 800 can be an electronic computer framework comprising and/or employing any number and combination of computing devices and networks utilizing various communication technologies, as described herein. The computer system 800 can be easily scalable, extensible, and modular, with the ability to change to different services or reconfigure some features independently of others. The computer system 800 may be, for example, a server, desktop computer, laptop computer, tablet computer, or smartphone. In some examples, computer system 800 may be a cloud computing node. Computer system 800 may be described in the general context of computer-executable instructions, such as program modules, being executed by a computer system. Generally, program modules may include routines, programs, objects, components, logic, data structures, and so on that perform particular tasks or implement particular abstract data types. Computer system 800 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 8, the computer system 800 has one or more central processing units (CPU(s)) 801a, 801b, 801c, etc. (collectively or generically referred to as processor(s) 801). The processors 801 can be a single-core processor, multi-core processor, computing cluster, or any number of other configurations. The processors 801, also referred to as processing circuits, are coupled via a system bus 802 to a system memory 803 and various other components. The system memory 803 can include one or more memory devices, such as read-only memory (ROM) 804 and a random access memory (RAM) 805. The ROM 804 is coupled to the system bus 802 and may include a basic input/output system (BIOS), which controls certain basic functions of the computer system 800. The RAM is read-write memory coupled to the system bus 802 for use by the processors 801. The system memory 803 provides temporary memory space for operations of said instructions during operation. The system memory 803 can include graphics memory, random access memory (RAM), read-only memory, flash memory, or any other suitable memory systems.

The computer system 800 comprises an input/output (I/O) adapter 806 and a communications adapter 807 coupled to the system bus 802. The I/O adapter 806 may be a small computer system interface (SCSI) adapter that communicates with a hard disk 808 and/or any other similar component. The I/O adapter 806 and the hard disk 808 are collectively referred to herein as a mass storage 810.

Software 811 for execution on the computer system 800 may be stored in the mass storage 810. The mass storage 810 is an example of a tangible storage medium readable by the processors 801, where the software 811 is stored as instructions for execution by the processors 801 to cause the computer system 800 to operate, such as is described hereinbelow with respect to the various Figures. Examples of computer program product and the execution of such instruction is discussed herein in more detail. The communications adapter 807 interconnects the system bus 802 with a network 812, which may be an outside network, enabling the computer system 800 to communicate with other such systems. In one aspect, a portion of the system memory 803 and the mass storage 810 collectively store an operating system, which may be any appropriate operating system to coordinate the functions of the various components shown in FIG. 8.

Additional input/output devices are shown as connected to the system bus 802 via a display adapter 815 and an interface adapter 816 and. In one aspect, the adapters 806, 807, 815, and 816 may be connected to one or more I/O buses that are connected to the system bus 802 via an intermediate bus bridge (not shown). A display 819 (e.g., a screen or a display monitor) is connected to the system bus 802 by a display adapter 815, which may include a graphics controller to improve the performance of graphics-intensive applications and a video controller. A keyboard, a mouse, a touchscreen, one or more buttons, a speaker, etc., can be interconnected to the system bus 802 via the interface adapter 816, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI), or PCI express. Thus, as configured in FIG. 8, the computer system 800 includes processing capability in the form of the processors 801, and storage capability including the system memory 803 and the mass storage 810, input means such as the buttons, touchscreen, and output capability including the speaker 823 and the display 819.

In some aspects, the communications adapter 807 can transmit data using any suitable interface or protocol, such as the internet small computer system interface, among others. The network 812 may be a cellular network, a radio network, a wide area network (WAN), a local area network (LAN), or the Internet, among others. An external computing device may connect to the computer system 800 through the network 812. In some examples, an external computing device may be an external web server or a cloud computing node.

It is to be understood that the block diagram of FIG. 8 is not intended to indicate that the computer system 800 is to include all of the components shown in FIG. 8. Rather, the computer system 800 can include any appropriate fewer or additional components not illustrated in FIG. 7 (e.g., additional memory components, embedded controllers, modules, additional network interfaces, etc.). Further, the aspects described herein with respect to computer system 800 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects.

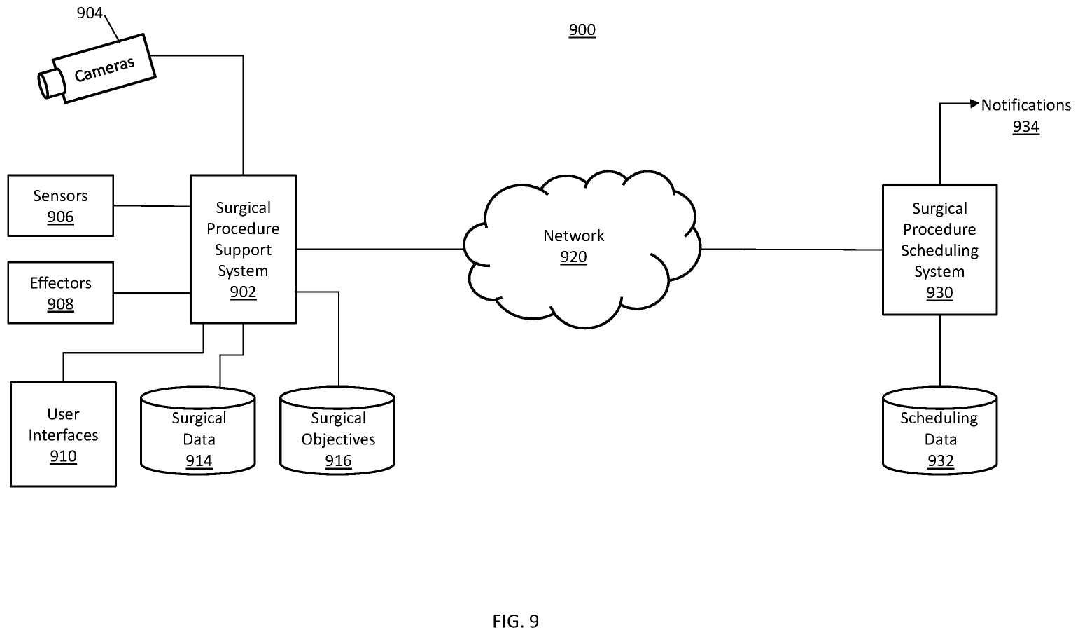

FIG. 9 depicts a surgical procedure system 900 in accordance with one or more aspects. The example of FIG. 9 depicts a surgical procedure support system 902 configured to communicate with a surgical procedure scheduling system 930 through a network 920. The surgical procedure support system 902 can include or may be coupled to the system 100 of FIG. 1. The surgical procedure support system 902 can acquire image data using one or more cameras 904. The surgical procedure support system 902 can also interface with a plurality of sensors 906 and effectors 908. The sensors 906 may be associated with surgical support equipment and/or patient monitoring. The effectors 908 can be robotic components or other equipment controllable through the surgical procedure support system 902. The surgical procedure support system 902 can also interact with one or more user interfaces 910, such as various input and/or output devices. The surgical procedure support system 902 can store, access, and/or update surgical data 914 associated with a training dataset and/or live data as a surgical procedure is being performed. The surgical procedure support system 902 can store, access, and/or update surgical objectives 916 to assist in training and guidance for one or more surgical procedures.

The surgical procedure scheduling system 930 can access and/or modify scheduling data 932 used to track planned surgical procedures. The scheduling data 932 can be used to schedule physical resources and/or human resources to perform planned surgical procedures. Based on the surgical maneuver as predicted by the one or more machine learning models 230 and a current operational time, the surgical procedure support system 902 can estimate an expected time for the end of the surgical procedure. This can be based on previously observed similarly complex cases with records in the surgical data 914. A change in a predicted end of the surgical procedure can be used to inform the surgical procedure scheduling system 930 to prepare the next patient, which may be identified in a record of the scheduling data 932. The surgical procedure support system 902 can send an alert to the surgical procedure scheduling system 930 that triggers a scheduling update associated with a later surgical procedure. The change in scheduling can be captured in the scheduling data 932. Predicting an end time of the surgical procedure can increase efficiency in operating rooms that run parallel sessions, as resources can be distributed between the operating rooms. Requests to be in an operating room can be transmitted as one or more notifications 934 based on the scheduling data 932 and the predicted surgical maneuver.

As surgical maneuvers and steps are completed, progress can be tracked in the surgical data 914 and status can be displayed through the user interfaces 910. Status information may also be reported to other systems through the notifications 934 as surgical maneuvers are completed or if any issues are observed, such as complications.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to aspects of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects of the present invention have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects of the invention are described herein with reference to the related drawings. Alternative aspects of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general-purpose microprocessors, application-specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

1. A computer-implemented method comprising:
computing, by a processor, using an encoder machine learning model, a plurality of frame features respectively corresponding to a plurality of video frames from a surgical video, each frame feature being a latent representation of the corresponding video frame from the surgical video;
generating, by the processor, using a decoder machine learning model, a position-aware temporal graph data structure that comprises a plurality of nodes and a plurality of edges, wherein each node represents a respective frame feature and an edge between two nodes indicates a relative position of the two nodes;
aggregating, by the processor, an embedding at each node, the embedding at a first node is computed by applying an aggregation function to the embedding of each node connected to the first node;
generating, by the processor, phase labels for the nodes based on the embedding at each node; and
identifying, by the processor, one or more surgical phases in the surgical video based on the phase labels.

2. The computer-implemented method of claim 1, wherein a subset of the nodes is associated with a first phase based on each of the subset of the nodes having the same phase label.

3. The computer-implemented method of claim 1, further comprising, storing, by the processor, information about the one or more surgical phases, the information identifying the video frames from the surgical video corresponding to the one or more surgical phases.

4. The computer-implemented method of claim 1, wherein the surgical video is captured using a camera that is one from a group comprising an endoscopic camera, a laparoscopic camera, a portable camera, and a stationary camera.

5. The computer-implemented method of claim 1, wherein the phase labels are generated using computer vision based on the latent representation.

6. The computer-implemented method of claim 1, further comprising, generating a user interface that comprises a progress bar with a plurality of sections, each section representing a respective surgical phase from the one or more surgical phases.

7. The computer-implemented method of claim 6, wherein the progress bar is updated in real-time as the surgical video is being captured and processed.

8. The computer-implemented method of claim 6, wherein each of the sections is depicted using a respective visual attribute.

9. The computer-implemented method of claim 8, wherein the visual attribute comprises at least one of a color, transparency, icon, pattern, and shape.

10. The computer-implemented method of claim 6, wherein selecting a section causes a playback of the surgical video to navigate to a surgical phase corresponding to the section.

11. The computer-implemented method of claim 1, wherein the decoder machine learning model is a graph neural network.

12. The computer-implemented method of claim 11, wherein the graph neural network comprises:
a first block comprising a series of calibration layers;
a second block comprising a predetermined number of graph convolution layers; and
a third block comprising a classification head.

13. A system comprising:
a machine learning system comprising:
an encoder that is trained to encode a plurality of video frames of a surgical video into a corresponding plurality of frame features; and
a temporal decoder that is trained to segment the surgical video into a plurality of surgical phases, each surgical phase comprising a subset of the plurality of video frames, wherein segmenting the surgical video by the temporal decoder comprises:
generating a position-aware temporal graph that comprises a plurality of nodes and a plurality of edges, each node represents a corresponding frame feature, and an edge between two nodes is associated with a time step between the video frames associated with the frame features corresponding to the two nodes;
aggregating, at each node, information from one or more adjacent nodes of the each node; and
identifying a surgical phase represented by each video frame based on the information aggregated at the each node.

14. The system of claim 13, wherein the machine learning system further comprises outputting the surgical phases identified.

15. The system of claim 13, wherein a surgical phase represented by each video frame is identified based on a latent representation of the video frame that is encoded into a frame feature.

16. The system of claim 13, wherein the position-aware temporal graph is generated using a graph neural network.

17. A computer program product comprising a memory device having computer-executable instructions stored thereon, which when executed by one or more processors cause the one or more processors to perform a method to autonomously identify surgical phases in a surgical video, the method comprising:
generating, using a machine learning system, a position-aware temporal graph to represent the surgical video, the position-aware temporal graph comprises a plurality of nodes and a plurality of edges, each node comprises a latent representation of a corresponding video frame from the surgical video, and an edge between two nodes is associated with a time step between the video frames corresponding to the two nodes;
for each layer of a graph neural network, aggregating, at each node, latent representations of adjacent nodes at a predefined time step associated with each layer, the graph neural network comprising a predetermined number of layers; and
identifying a surgical phase represented by each video frame based on the aggregated information at the each node.

18. The computer program product of claim 17, wherein the each layer of the graph neural network is associated with a distinct predefined time step.

19. The computer program product of claim 17, wherein the method further comprises storing a starting timepoint and an ending timepoint of the surgical phase based on a set of sequential video frames identified to represent the surgical phase.

20. The computer program product of claim 17, wherein the surgical video is a real-time video stream or the surgical video is processed post-operatively.

21. (canceled)
